(19) United States
(12) Patent Application Publication
(10) Pub. No.: US 2026/0118057 A1
(43) Pub. Date: Apr. 30, 2026

(54) DIRECT CONTACT SPRAY FREEZING SYSTEM

(71) Applicant: IMA LIFE NORTH AMERICA, INC., Tonawanda, NY (US)

(72) Inventors: Francis W. DeMarco, North Tonawanda, NY (US); Marco G. Manfredoni, Buccinasco (IT)

(73) Assignee: IMA LIFE NORTH AMERICA, INC., Tonawanda, NY (US)

(21) Appl. No.: 19/157,571

(22) PCT Filed: Feb. 21, 2024
(86) PCT No.: PCT/US2024/016713

§ 371 Date: Aug. 18, 2025

Related U.S. Application Data
(60) Provisional application No. 63/447,388, filed on Feb. 22, 2023.

(51) Int. Cl. F26B 5/06

(52) U.S. Cl. CPC F26B 5/06

(57) ABSTRACT

A direct contact spray freezing system includes freezing tower having an interior chamber, in which a bulk product is delivered in the form of liquid droplets that vertically fall into the interior chamber of the freezing tower. A coolant fluid capable of contacting and directly freezing the liquid droplets within the interior chamber is also delivered, wherein the liquid droplets are transformed into frozen particles collected at a lowermost portion of the tower. The coolant fluid is delivered in the form of a sub-cooled cryogenic mist made up of coolant fluid microparticles into which the liquid droplets vertically pass, and in which each of the coolant fluid microparticles are substantially smaller than the liquid droplets delivered to the interior chamber of the freezing chamber such that the structural integrity of the formed liquid droplets is maintained and the vertically falling trajectory of the liquid droplets is not significantly affected during freezing.

### CROSS REFERENCE TO RELATED APPLICATION

This application claims priority under relevant portions of 35 U.S.C. § 119 and 35 U.S.C. § 120 to U.S. patent application Ser. No. 63/447,388, entitled DIRECT CONTACT SPRAY FREEZING SYSTEM, filed Feb. 22, 2023, the entire contents of which are herein incorporated by reference.

### TECHNICAL FIELD

This application generally relates to the field of lyophilization and more specifically to a direct contact spray freezing system for use in freeze drying apparatus.

### BACKGROUND

Freeze drying or lyophilization is a process that removes a solvent or suspension medium, typically water, from a product. While the present disclosure uses water as the exemplary solvent, other solvents, such as but not limited to alcohol, may also be removed in freeze drying processes.

In a freeze drying process for removing water, the water in the product is frozen to form ice and, under vacuum, the ice is sublimed and the water vapor flows toward a condenser. The water vapor is condensed on the condenser as ice and is later removed from the condenser. Freeze drying is particularly useful in the pharmaceutical industry as the integrity of the product is preserved during the freeze drying process and product stability can be maintained and guaranteed over relatively long periods of time. The freeze dried product is, ordinarily, but not necessarily a biological substance.

Pharmaceutical freeze drying is often an aseptic process that requires sterile conditions within the freeze drying chamber(s). For these bulk products, it is critical to insure all components of the freeze drying system that come into contact with the product are sterile.

Most bulk freeze drying in aseptic conditions is done in a freeze dryer designed for vials, in which the bulk product is placed in a plurality of trays that are sized and configured for holding the vials. In one example of a bulk freeze drying system 100 shown in FIG. 1, a batch of product 102 is placed in freeze drying trays 104 within a freeze drying chamber 106. Freeze dryer shelves 108 are used to support the trays 104 and to transfer heat to and from the trays 104 and the product 102 as required by the process. A heat transfer fluid flowing through conduits within the shelves 108 is used to remove or add heat.

Under vacuum, the frozen product 102 is heated slightly to cause sublimation of the ice within the product. Water vapor resulting from the sublimation of the ice flows through a passageway 110 into a condensing chamber 112 containing condensing coils or other surfaces 114 maintained below the condensation temperature of the water vapor. A coolant is passed through the coils 114 to remove heat, causing the water vapor to condense as ice on the coils.

Both the freeze drying chamber 106 and the condensing chamber 112 are maintained under vacuum during the process by a vacuum pump 116, the latter of which is connected to the exhaust of the condensing chamber 112. Non-condensable gases contained in the chambers 106, 112 are removed by the vacuum pump 116 and exhausted at a higher pressure outlet 118.

Tray dryers are designed for aseptic vial drying and are not optimized to handle bulk product. The product must first be manually loaded into the trays, freeze dried, and then manually removed from the trays. Moreover, handling of the trays is difficult, and creates the risk of liquid spill. Heat transfer resistances between the product and the trays, and between the trays and the shelves, sometimes causes irregular heat transfer. Dried product must be removed from the trays after processing, resulting in product handling loss.

Because the foregoing bulk process is performed on a large mass of product, agglomeration into a “cake” also often occurs, and milling is therefore required in order achieve a suitable powder and a uniform particle size. Cycle times may be longer than necessary due to resistance of the large mass of product to heating and the poor heat transfer characteristics between the plurality of trays, the product and the shelves.

Spray freeze drying has since been suggested, wherein a liquid substance is sprayed into a low temperature, low pressure environment, and water from the resulting frozen particles is sublimated by exposing the falling particles to radiant heat (see e.g., U.S. Pat. No. 3,300,868). This process is limited to materials from which water may be removed rapidly, while the particles are airborne, and requires radiant heaters in a low temperature environment, reducing efficiency.

Spray freezing of a product by atomizing the product together with liquid nitrogen (LN2) or a cold gas has been suggested in conjunction with atmospheric freeze drying using a desiccating gas, such as nitrogen. An example of this form of process is shown in U.S. Pat. No. 7,363,726. Frozen particles are collected in a drying vessel having a bottom with a porous metal filter plate. The desiccating gas is passed through the product, creating a partial pressure of water vapor from the product over the dry desiccating gas, causing sublimation and/or evaporation of the water contained in the product. Such a process is not well suited for aseptic processing, because both the cold gas and the desiccating gas must be sterile. The process may also consume large amounts of nitrogen. Atmospheric drying is typically slower than vacuum drying of equivalent amounts of powder.

The use of atomizing product nozzles in a spray freezing tower, as described in the above referenced '726 patent and U.S. Pat. No. 9,052,138, are inefficient as a considerable amount of frozen product tends to collect on the interior surfaces of the tower housing. One technique, described in U.S. Pat. No. 11,148,463B2 produces a stream of liquid droplets in a freezing tower in which a coolant fluid is circulated within a cavity formed within the sidewalls of the freezing tower in relation to a product dispensed within the tower and indirect contact therewith. There is a prevailing and current need in the field to improve the aseptic freezing process of a liquid product for purposes of freeze drying. There is a further longstanding and persistent need to provide a direct contact spray freezing system that eliminates wasted frozen product and produces repeatable, uniform sized frozen particles or beads for purposes of drying.

### BRIEF DESCRIPTION

Therefore and according to one aspect of the present invention, there is provided a direct contact spray freezing system comprising a freezing tower having an interior chamber, and at least one means for delivering bulk product in the form of liquid droplets to the interior chamber of the freezing tower. There is further provided at least one means for delivering a coolant fluid capable of contacting and directly freezing the liquid droplets within the interior chamber of the freezing tower, wherein the liquid droplets are transformed into frozen particles collected at a lowermost portion of the freezing tower and wherein the coolant fluid is delivered in the form of a sub-cooled cryogenic mist made up of coolant fluid microparticles, and in which each of the coolant fluid microparticles are substantially smaller than the liquid droplets being delivered to the interior chamber of the tower housing.

The coolant fluid microparticles have an average size that is small enough not to disturb the structural integrity of a liquid droplet when in direct contact therewith, or significantly affect the trajectory of the falling liquid particles as the particles fall under the force of gravity through the sub-cooled cryogenic mist. A ratio of the average size of the liquid droplets to that of the average size of the coolant particles according to at least one embodiment preferably should be at least 2:1. According to at least one embodiment, the average size of each liquid droplet is about 600 microns and the average size of each coolant fluid microparticle is about 10 microns to about 100 microns.

In at least one embodiment, the coolant fluid and the liquid droplets are each delivered to an upper portion of the freezing tower. In at least one version, the means for delivering the coolant fluid includes means for sterilizing the coolant fluid prior to delivery to the freezing tower.

The means for delivering the bulk product to the freezing tower can include a droplet generator having one or more vibratory nozzles, which are configured to produce liquid droplets that vertically fall from the one or more vibratory nozzles under the force of gravity.

In at least one version, the means for delivering the bulk product in the form of liquid droplets further comprises a liquid reservoir and one or more hollow tubular members disposed between the liquid reservoir and the one or more vibratory nozzles, and according to at least one embodiment the tubular members are configured for single product use or single use. According to at least one embodiment, means are further provided for maintaining the bulk product in the product reservoir at a predetermined pressure (and temperature) prior to delivery to the one or more vibratory nozzles.

According to at least one embodiment, the means for delivering the bulk product further comprises means for initially cooling the bulk product to a predetermined temperature prior to delivering the bulk product as liquid droplets to the interior chamber of the freezing tower.

Preferably, the means for delivering the coolant fluid comprises one or more coolant nozzles configured to create the sub-cooled cryogenic mist of coolant fluid microparticles in which the coolant fluid can be liquid nitrogen and in which the interior chamber of the freezing tower is maintained at ambient pressure.

In at least one embodiment, the means for delivering coolant fluid for the herein described system further includes one or more additional coolant nozzles configured to condition the interior chamber to a predetermined temperature prior to delivery of the liquid droplets.

According to another aspect, there is provided a process for freezing liquid material within a direct contact spray freezing system, the process comprising delivering bulk product material in the form of liquid droplets released into an interior chamber of a freezing tower; and providing a coolant fluid in the form of a sub-cooled cryogenic mist through which the liquid droplets vertically pass through the interior chamber of the freezing tower for directly freezing the liquid droplets into frozen particles. The sub-cooled cryogenic mist is made up of a plurality of coolant fluid microparticles directly contacting the liquid droplets in which the coolant particles are substantially smaller in size than that of each liquid droplet such that the structural integrity of the liquid droplets is not disturbed and the trajectory of each vertically passing liquid droplet is not substantially affected so as to cause the droplets to be directed into contact with an inner wall of the freezing tower. According to at least one version, the average size of the liquid droplets delivered into the interior of the freezing tower is at least 2 times larger than the average size of the coolant particles in the coolant mist. In at least one embodiment, either the coolant fluid or the coolant fluid and the liquid product are sterilized prior to delivery.

In at least one embodiment, the liquid droplets are released from one or more vibratory nozzles at a frequency that permits each liquid droplet to be released under the force of gravity.

In at least one version, the process further comprises filtering excess coolant fluid away from the frozen particles, the latter being collected at a bottom portion of the freezing tower.

Preferably, the freezing tower is maintained at ambient pressure during the freezing process, wherein the bulk product is maintained at a constant pressure (and temperature) prior to delivery of the liquid to the interior of the freezing tower.

In at least one embodiment, the process further comprises pre-conditioning or conditioning the interior chamber of the freezing tower to a predetermined temperature prior to delivery of the liquid droplets. In an exemplary version, the conditioning of the interior chamber of the freezing tower further comprises monitoring an exhaust temperature of the freezing tower and comparing the exhaust temperature to a predetermined threshold temperature, wherein delivery of the liquid droplets commences only when the exhaust temperature has been cooled to the predetermined threshold temperature or cooler. According to at least one version, the foregoing part of the process can comprise opening one or more additional coolant nozzles when the monitored exhaust temperature has not reached the predetermined threshold temperature and isolating and closing the one or more additional coolant nozzles when the predetermined threshold has been reached.

At least one of the coolant fluid or the coolant fluid and the bulk product are sterilized prior to delivery to the interior chamber of the freezing tower. Preferably, a filtered gas is used to sterilize either the coolant fluid or coolant fluid and bulk product. Preferably, the coolant fluid can be liquid nitrogen and the filtered gas can be nitrogen gas. Additionally, the freezing tower itself can be periodically sterilized using steam or other means between uses.

An advantage of the herein described freezing tower is that of efficiency given that less frozen product is caused to adhere to the inner sidewalls of the freezing chamber.

Another advantage is that the formed and frozen product beads are consistent in terms of their overall size from formation through the point of collection.

Yet another advantage is that in the herein described direct contact spraying system, the heat exchange coefficient is significantly enhanced, which results in both reduced permanance time and reduced equipment (freezing tower) size.

Yet another advantage is that the herein described spray freezing system permits sterility of the cooling fluid and liquid product, as well as the freezing tower and related components.

These and other features and advantages will be readily apparent from the following Detailed Description, which should be read in conjunction with the accompanying drawings.

### SHORT DESCRIPTION OF THE DRAWINGS

FIG. 1 is a representation of a traditional bulk freeze drying system;

FIG. 2 is a schematic view of a direct contact spray freezing system in accordance with aspects of the present invention;

FIG. 3 is the schematic view of the direct contact spray freezing system of FIG. 2, illustrating a conditioning process for the freezing tower prior to dispense of liquid product;

FIG. 4(a) is a partial top sectioned view of the direct contact spray freezing system of FIGS. 2 and 3;

FIG. 4(b) is a partial side sectional view of the droplet generator of the direct contact spray freezing system of FIGS. 2, 3 and 4(a);

FIG. 5 is the schematic view of the direct contact spray freezing system of FIGS. 2-4, illustrating the freezing of liquid droplets in accordance with aspects of the present invention;

FIG. 6 is a flow chart of an exemplary process for freezing liquid droplets directly with a coolant fluid in accordance with aspects of the present invention;

FIG. 7 depicts a direct contact spray freezing system according to another exemplary embodiment and in accordance with aspects of the present invention;

FIG. 8 depicts another alternative embodiment of a direct contact spray freezing system in accordance with aspects of the present invention; and

FIG. 9 depicts yet another alternative embodiment of a direct contact spray freezing system in accordance with aspects of the present invention.

### DETAILED DESCRIPTION

The following description relates to exemplary embodiments of a spray freezing system in which liquid droplets of a product of a controlled size are caused to fall under the influence of gravity and are directly contacted with a sub-cooled cryogenic mist formed from a cooling or coolant fluid, such as liquid nitrogen. The herein described system is designed such that the structural integrity and the trajectory of the vertically falling liquid droplets are not significantly affected when passing through the sub-cooled cryogenic mist.

The processes and apparatus may advantageously be used in freezing and drying pharmaceutical products that require aseptic or sterile processing, such as injectables. The methods and processes may also be used, however, in processing materials that do not require aseptic processing, but require moisture removal while preserving structure, and require a dried product in powder form. For example, ceramic/metallic products used in superconductors or for forming nanoparticles or microcircuit heat sinks may be produced using the herein disclosed techniques.

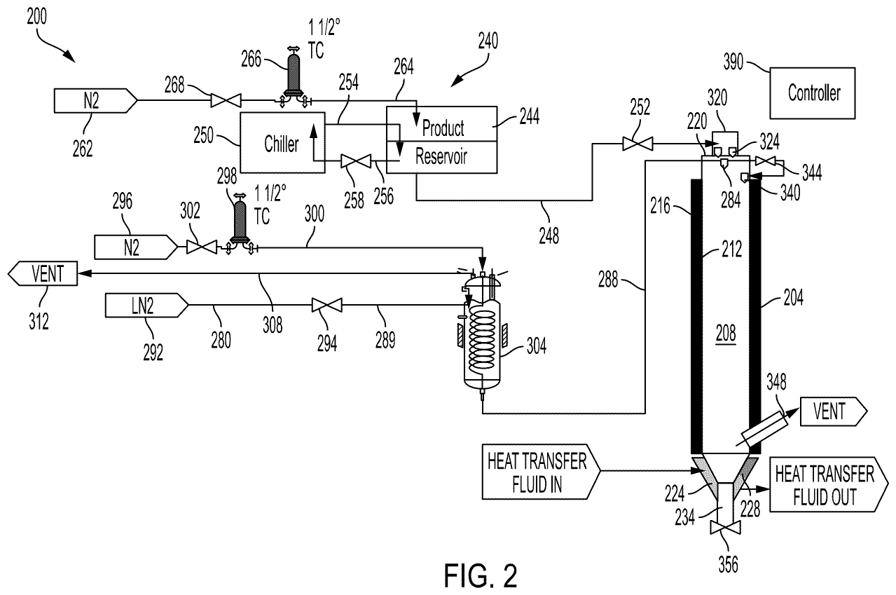

The systems and methods described herein may be performed in part by an industrial controller and/or computer used in conjunction with the processing equipment described herein. The equipment is controlled by one or more plant logic controllers (PLC) such as controller 390 which is shown in FIGS. 2, 3 and 5, that controls the opening and closing of various valves as discussed herein and further having processing logic for valves, motors, and the like. An interface with the PLC is provided via a PC. The PC loads a well-defined recipe to the PLC to run. The PLC will upload historical data to the PC from the run for storage. The PC may also be of use for manual control of the devices/apparatus, operating specific steps for freezing.

The PLC and the PC can include central processing units (CPU) and memory, as well as input/output (I/O) interfaces connected to the CPU via a bus. The PLC is connected to the processing equipment via the I/O interfaces to receive data from sensors monitoring various conditions of the processing equipment such as temperature, position, speed, flow rate and the like. The PLC is further connected to operate devices that are part of the processing equipment.

The memory may also include random access memory (RAM) and read-only memory (ROM). The memory may also include removable media such as a disk drive, tape drive, and the like or a combination thereof. The RAM may function as a data memory that stores data used during execution of programs in the CPU, and is used as a work area. The ROM may function as a program memory for storing one or more programs including the steps executed in the CPU. The program may reside on the ROM, and may be stored on the removable media or on any other non-volatile computer-usable medium in the PLC or the PC, or computer readable instructions stored thereon for execution by the CPU or other processor (including ASIC) to perform the methods disclosed herein.

A first exemplary embodiment is shown in FIGS. 2-6 of an exemplary direct contact spray freezing system 200. In brief, the spray freezing system 200 is defined by a freezing vessel or tower 204, a liquid product delivery subsystem 240 for delivering a bulk product in liquid form to the confines of the freezing tower 204, and a coolant fluid delivery subsystem 280 for delivering a coolant fluid to the confines of the freezing tower 204. Each of the foregoing will now be described in greater detail.

First, the freezing tower 204 is defined by a structure having a defined and vertically extending interior cavity (herein also referred to as a chamber) 208, which further includes an inner circumferential sidewall 212 and an outer circumferential sidewall 216, and further including respective upper and lower portions 220, 224. According to at least one version, a cavity can be formed between the inner and outer sidewalls 212, 216. Preferably, the freezing tower 204 is well-insulated such as within the afore mentioned cavity between the inner and outer circumferential sidewalls 212, 216, for example, vacuum insulated or other suitable techniques, in order to maintain a sufficiently cold environment within the defined interior chamber 208 for the delivered coolant fluid and product, and which as described in greater detail below, maximizes the duration of a coolant fluid (liquid nitrogen) microdroplet as a liquid before evaporation due to heat leak.

The upper or top portion 220 of the freezing tower 204 is configured to retain one or more vertically disposed nozzles 324, the latter forming a portion of a vibratory droplet generator 320. The lower portion 224 of the freezing tower 204 is defined, according to this exemplary embodiment, by a hollow frusto-conical configuration including an inwardly tapering bottom wall 228 with a product opening or port 234, the latter being formed at a bottommost portion of the tower 204. As discussed in a later portion of this discussion, the design of the bottom portion 224 of the freezing tower 204 can be suitably varied for purposes of collecting the formed frozen product material and/or vaporizing excess coolant fluid.

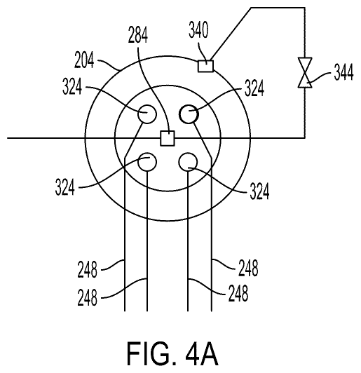

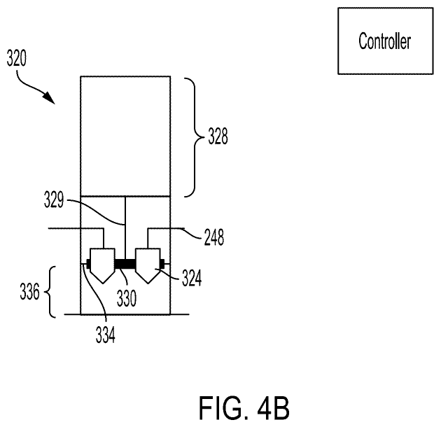

The product delivery subsystem 240 is defined by a product source or reservoir 244 that is linked through one or more connective passageways or conduits 248 and one or more valves 252, such as gate valves, to the vibratory droplet generator 320, which includes a corresponding number of droplet nozzles 324. According to this specific embodiment, a total of four (4) vertically extending droplet nozzles 324 are separately linked by respective passageways 248 and valves 252 to the product reservoir 244, as shown in spaced relation in FIG. 4(a). Each droplet nozzle 324 is preferably configured to receive the same flow rate from the product reservoir 244, wherein flow monitoring of each flow path/passageway 248 may be monitored via a flow meter (not shown). Additionally, each fluid flow path can be hard piped, or alternatively couplable tubing can be used that is configured for single use or single product use.

In this embodiment and with reference to FIG. 4(b), a vibratory drive motor 328 is connected via an extension 329, such as a connecting rod, leading from the drive motor 328 to a nozzle disc 330 upon which the droplet nozzles 324 are mounted through openings that are formed in the disc 330. According to the herein described embodiment, the nozzle disc 330 is made from metal. Each of the fluid flow paths from the product reservoir is connected directly to a corresponding droplet nozzles(s) 324 by a flexible element which does not impede the vibration of the vibrating nozzle disc 330, as driven by the vibratory drive motor 328. According to one version, the nozzle disc 330 is connected to a flexible diaphragm 334 to create a physical barrier between the nozzle tip(s) in the sterile environment/space 336 of the freezing tower 204 and the tubing/vibratory drive motor 328 in the non-sterile space. The product delivered to each droplet nozzle 324 is forced through an orifice by pressure and the separated from the nozzle tip by the vibration of the nozzle body and gravity to create individual droplets or product beads. Typical drive frequencies are in the range of about 2000 Hz. By controlling the vibratory rate, and the orifice size of each droplet nozzle 324, the product bead size may be altered. Typical nozzle diameters to produce a 600 um bead are on the order of about 150 microns. Summarily, the vibratory droplet generator 320 produces uniform product droplets having a relatively tight and narrow size distribution that are caused to fall downwardly under gravity along a vertical trajectory toward the bottom of the freezing tower 204. The production of controlled and predictable product droplets is important in drying and filling of the bead material.

According to this specific embodiment, the product delivery subsystem 240 further includes a chiller 250, which is coupled to the product reservoir 244 via respective inlet and outlet passageways 254, 256. The outlet passageway 256 further includes a valve 258 wherein the chiller 250 is configured to keep the stored bulk product at a controlled temperature prior to delivery of product to the freezing tower 204. In addition and according to this embodiment, a dry gas, such as nitrogen gas (N₂), is provided from an appropriate source 262 and can be directed to the product reservoir 244 via a passageway or conduit 264 as regulated by a valve 268, wherein the gas is first passed through a filter 266 that is intermediately disposed between the source of gas 262 and the product reservoir 244 to create a sterile gas. In accordance with this embodiment, the bulk product is temporarily stored in the product reservoir 244. Sterile nitrogen, that is, the nitrogen gas that passes through the filter 266, is delivered to the product reservoir 244 to pressurize the vessel, in order to ensure consistent feeding of the stored bulk product liquid solution and delivery of the liquid product to the vibratory droplet generator 320. As noted, the product reservoir 244 may optionally be in communication with an external cooling device, such as the chiller 250, in order to maintain the liquid product within a specific non-freezing temperature range prior to entering the freezing tower 204.

The coolant delivery system 280 according to this exemplary embodiment includes one or more coolant nozzles 284 that are linked via conduits or passageways 288, 289 from a source of coolant fluid 292, which according to this specific embodiment contains liquid nitrogen (LN2), as controlled by a shut off valve 294. The one or more coolant nozzles 284 are disposed in the upper portion 220 of the freezing tower 204 beneath the vibratory droplet generator 320, creating an air pocket therebetween, but it will be understood that the locations of these latter nozzles can be suitably varied within the chamber 208. The formed air pocket is intended to keep the droplet nozzles 324 warmer, and therefore prevent bulk product from freezing prior to delivery. Alternatively and in lieu of the formed air pocket, a nozzle heater (not shown) can be provided. It will be understood, however, that use of a nozzle heater could adversely and inconsistently influence the controlled product temperature. According to yet another alternative, a separate gas line (not shown) could be provided between the coolant nozzle(s) 289 and the vibratory nozzles 324 in order to create positive pressure against the vibratory nozzles 324.

According to this embodiment and prior to injection of coolant fluid into the freezing tower 204, the coolant fluid must be rendered aseptic (i.e. be sterilized) To accomplish this, a dry gas (nitrogen gas N2) is further provided from a source 296 and directed via a passageway or fluid conduit 300 through a filter 298 to create a sterile gas, with the flow of the sterile gas being regulated by a valve 302. The sterile gas and the coolant fluid are each directed via their respective passageways 300, 289 to an intermediately disposed heat exchanger 304 in order to condense the gas into its liquid form. In this embodiment, the gas travels through a coil of the heat exchanger 304 that is submerged within the liquid nitrogen. The submerged coil isolates the sterile gas from the non-sterile liquid, while also allowing heat exchange to occur. Gas originating from the evaporation of the coolant fluid from source 292 is removed from the heat exchanger 304 via a passageway 308 to a vent 312 and the now sterile coolant fluid (LN2) is directed to the freezing tower 204 and more specifically, the coolant nozzles 284 via the passageway 288.

According to this exemplary embodiment and before the introduction of the product droplets into the interior chamber 208 of the freezing tower 204, it is preferable for the processing atmosphere to be preconditioned within the chamber 208. This preconditoning of the chamber 208 is preferably done in order to establish stable and homogenous conditions throughout the volume of the interior chamber 208 and hence, insure the quality of the freezing process prior to the injection of liquid droplets. More specifically, the preconditioning minimizes product loss at the start of the freezing process and improves overall product yield. Moreover and during preconditioning, air is evacuated from the passageway 288, with oxygen removal from the freezing tower 204 and reduced humidity being advantageous results. A stable temperature is achieved, wherein the interior chamber 208 is effectively filled with sterile LN2, stabilizing the operation of the coolant nozzle(s) 284. This processing step also enables greater overall consistency in the freezing process.

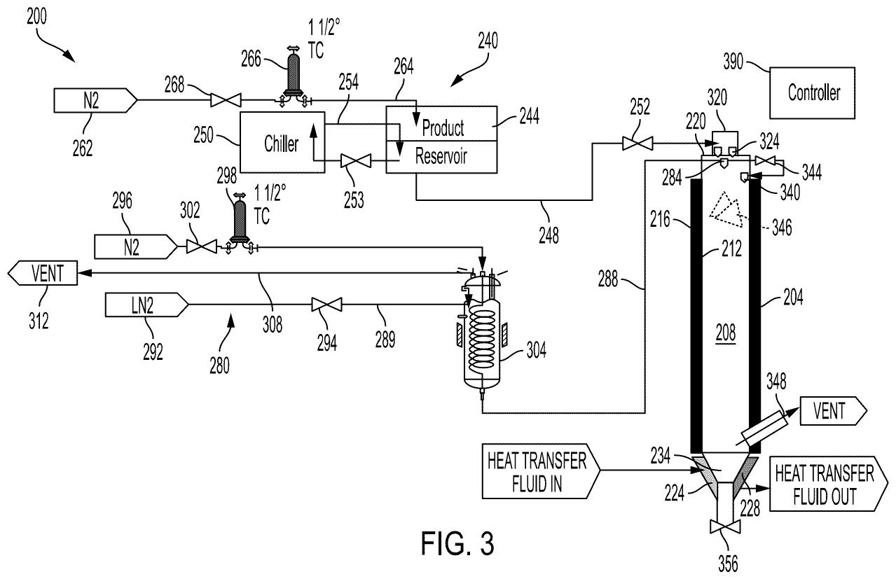

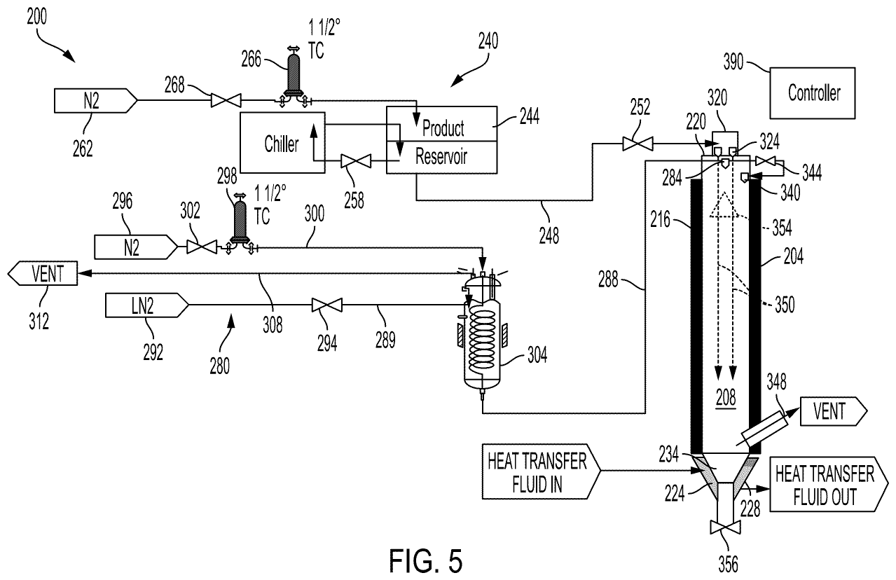

This conditioning is accomplished by spraying the same sterile liquid nitrogen used for freezing through the nozzle 284 as well as one or more additional nozzle(s) 340, which may be of a higher flow rate than the nozzle(s) 284, in order to pre-cool the interior chamber 208 in a reasonable amount of time, this spray being shown schematically as 346 in FIG. 3. The passageway 288 extends from the coolant nozzle 284 to the additional nozzle(s) 340 (one shown in FIG. 4(b)), which further includes a shut off valve 344. The additional nozzle(s) 340 is actively controlled by measuring an exhaust temperature of the freezing tower 204. Once the freezing tower 204 sees a temperature drop below a predetermined threshold, the additional nozzle(s) 340 are isolated via valving 344 and the flow of liquid nitrogen continues only through the nozzle(s) 284. The same nitrogen upon vaporizing on the warm surfaces of the freezing tower 204 provides for a purging of the air from the freezing system 200. The vaporized nitrogen and entrained air can be exhausted from the freezing tower 204 via the process vent 348, the latter being schematically shown in FIG. 3. Once this conditioning is complete, the freezing of the liquid droplets 350 vertically passing through a sub-cooled cryogenic mist 354 can commence, as shown schematically in FIG. 5.

The freezing of the falling liquid droplets occurs by direct contact of the droplets with the coolant fluid. In order to achieve this type of freezing, it is necessary to create the sub-cooled cryogenic mist 354, or fog, of small coolant fluid (LN2) microparticles. According to this exemplary embodiment, the sub-cooled cryogenic mist 354 is produced by the one or more cooling nozzle(s) 284 disposed beneath the vibratory droplet generator 324 within the freezing tower 204, thereby transferring the heat of vaporization from the liquid nitrogen (LN2) to the warmer product. Further, this collision between the respective liquid droplets 350 and coolant fluid (LN2) microparticles must be in a manner, where the size and velocity of the liquid nitrogen microdroplets do not significantly impact the structural integrity of the product droplets (that is, do not break or rupture the droplets), when each of the particles come into contact with one another nor affect the trajectory of the falling liquid droplets by deflecting the vertically passing liquid droplets toward or into contact with the inner circumferential side wall 212 of the freezing tower 204. The sub-cooled cryogenic mist 354, or fog, is created using a hydraulic spray nozzle capable of atomizing the liquid nitrogen, such as Spraying Systems Co., Fine Spray Nozzle, ¼″M series, or other suitably designed atomizing nozzle. This atomizing nozzle is capable of producing coolant fluid microdroplets in the 10 to 100 micron size, as compared to the product droplet size of nominally 600 micron size.

Accordingly, the average size of each liquid droplet 350 (e.g., 600 microns) is considerably larger than the average size of each coolant fluid (LN2) microdroplet of the formed sub-cooled cryogenic mist 354 (about 10-100 microns). It will be understood that other suitable ratios, those that are at least 2:1 (liquid droplet size: coolant fluid microparticle size) are preferably desired so as not to disturb the integrity of the falling product droplets, nor the falling trajectory thereof, as they pass through the sub-cooled cryogenic mist 354, as created by the cooling nozzle(s) 284.

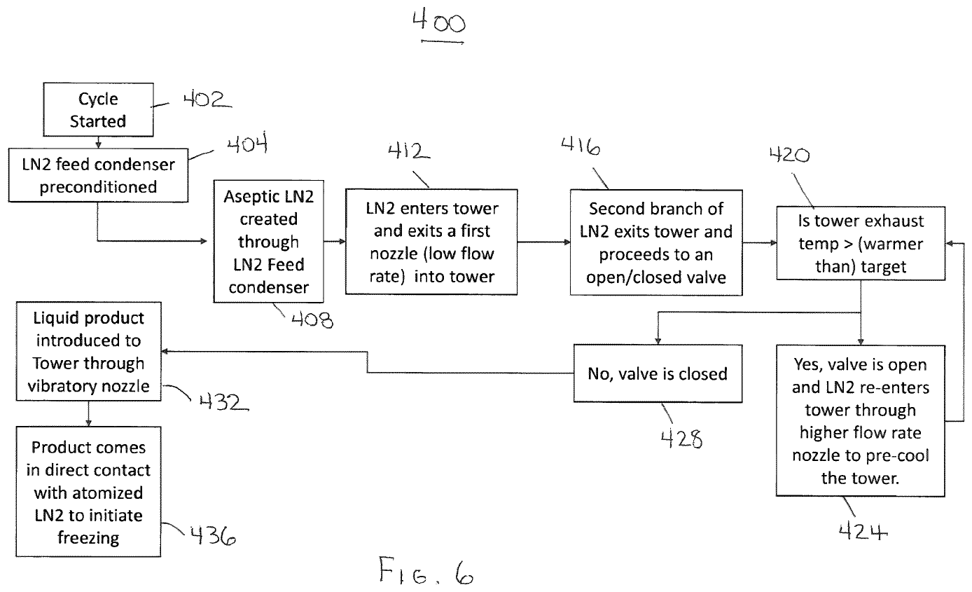

An exemplary process 400 is depicted in FIG. 6, with portions of this process being further depicted sequentially in FIGS. 2, 3 and 5. More specifically, and in terms of the actual process, a cycle initially begins at step 400 with the coolant fluid (liquid nitrogen) feed condenser being preconditioned at step 404 and in which the bulk product has delivered under pressure from the product reservoir 344 to the vibratory droplet generator 320. The aseptic liquid nitrogen created through the heat exchanger 304, step 408, enters the freezing tower 204 and more specifically, the interior chamber 208 and exits via the cooling nozzles 284 at a first (low) flow rate, step 412. A second branch of the liquid nitrogen passing through the first coolant nozzle(s) 284 and a valve 344 toward a second coolant nozzle 340 per step 416. The exhaust temperature of the freezing tower 204 is monitored in real time and compared to a threshold or target temperature or temperature range, step 420. If the monitored temperature is warmer than the threshold temperature, then coolant fluid is sprayed into the chamber 208 by each of the nozzles 284, 340, the latter nozzle(s) preferably having a higher flow rate than the first coolant nozzle(s) 284. If the monitored exhaust temperature is dropped to or below threshold or target temperature, then the valve 344 is closed and the controller 390 initiates the vibratory droplet generator 320 to initiate dispense of the liquid droplets through the vibratory (droplet) nozzles 324, step 432, in which the liquid product droplets fall into contact under the force of gravity and into direct contact with the atomized coolant fluid microparticles of the formed sub-cooled cryogenic mist 354, FIG. 5, to initiate freezing, per step 436.

As described in this and other embodiments, the orientation of the coolant fluid spray nozzles may be in any manner that produces a dense field or mist of micro-droplets for the product droplets to vertically pass through. This orientation may include the coolant fluid spraying upward, downward, or be directed in from some horizontally angled nozzle.

As described above, the liquid droplets are frozen in their downward passage through the formed mist of liquid nitrogen. At the bottom portion 224 of the freezing tower 204, the frozen product beads, and any residual and unvaporized liquid nitrogen can be separated from one another. According to one version, this can be done using an inclined screen or membrane (not shown) having a mesh size configured to retain and move the particles towards a collection nozzle or port, while allowing the unvaporized coolant fluid (LN2) to fall through the inclined screen to the bottom of the freezing tower 204. This unvaporized liquid nitrogen can then be removed from the bottom of the freezing tower 204, or alternatively can be heated to vaporize within the tower. Vaporized liquid nitrogen can be vented at the top or bottom of the freezing tower. In order to maintain an aseptic (sterile) environment, the vent path will require the filtering of the air/nitrogen through a sterile filter system (0.2 micron or better). The overall shape/configuration of the lower or bottom portion of the freezing tower 204 can be suitably varied to provide the foregoing features.

Alternatively, the unvaporized coolant fluid (liquid nitrogen) can be removed using a jacket formed at the bottom portion 224 of the freezing tower 204, as shown in FIGS. 2, 3 and 5. A cavity specific to only the tapering bottom walls 228 of the bottom portion 224 of the freezing tower 204 can receive a circulated heat transfer fluid, such as silicone oil, which can be used to vaporize excess coolant fluid (LN2) and vent same from the freezing tower 204 via vent 348. The collected frozen product beads are retained in the product vent 234, which is isolated from remaining apparatus of a freeze drying system, such as by a valve 356. In the herein discussed manner or other variant, the frozen product beads can be extracted from the freezing tower 204 to undergo freeze drying within an attached freeze dryer (not shown), or removed from the freezing tower in an insulated container (not shown) to be placed in a separate freeze dryer. The freezing tower 204 is configured to permit sterilization of the interior chamber 208 following use, using steam or other means, which can ported therein.

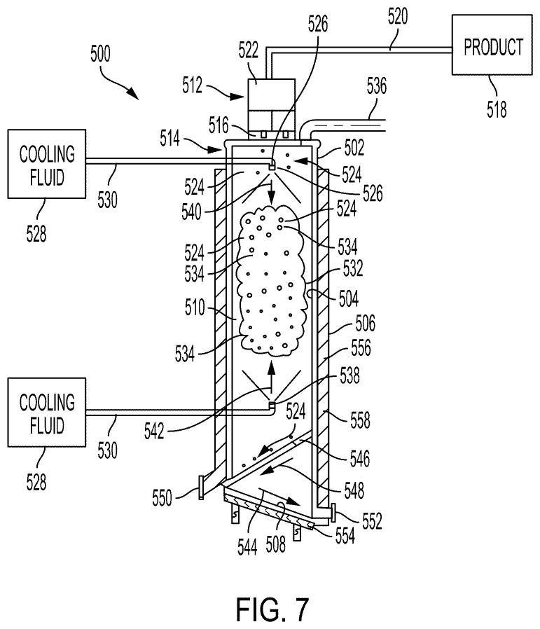

Other suitable configurations are described in the following embodiments. As will be apparent from the discussion, specific positioning of the product nozzles and the coolant nozzles in the freezing tower is not necessarily limited to those described in the prior embodiment. For example and according to another exemplary embodiment in FIG. 7, a direct contact spray freezing system 500 is shown. The system 500 includes a freezing vessel or tower 502 that is oriented vertically, the tower 502 having an inner circumferential sidewall 504 and a bottom wall 508 that define a freeze chamber 510. The freeze chamber 510 further includes an outer sidewall 506 that is spaced apart from the inner sidewall to form a cavity 505 between the inner and outer sidewalls 504, 506. The system 500 also includes a vibratory prilling head 512 located on a top or upper portion 514 of the freeze tower 502 having one or more product nozzles 516. The prilling head 512 is connected to a product source 518, such as liquid product in bulk form, by a fluid product passageway or conduit 520 that provides fluid communication between the product source 518 and the prilling head 512. The prilling head 512 includes a vibration unit 522 that generates product droplets or beads 524 having a nominally fixed diameter, which are then sheared from the product nozzle 516 sequentially to form a stream of droplets that fall under the force of gravity toward the bottom of the freeze chamber 510. The prilling head can be designed, for example, like that of the previously described vibratory droplet generator 320, FIG. 2.

In accordance with an aspect of the invention, the system 500 includes at least one cooling nozzle (a first cooling nozzle 526) connected to a cooling fluid source 528, such as liquid nitrogen, by a cooling fluid conduit 530 that provides fluid communication between the cooling fluid source 528 and the first cooling nozzle 526. Though not shown in this and succeeding embodiments, FIGS. 7-9, each of the cooling fluid and liquid product can be sterilized as previously described prior to delivery to the freezing tower 502. The first cooling nozzle 526 is configured to atomize the cooling fluid (LN2) and spray the liquid nitrogen vertically downward according to this embodiment, into the freezing chamber 510 to form a cryogenic fog or mist 532 of small liquid nitrogen particles (liquid nitrogen microdroplets 534). The product beads 524 sheared from the one or more product nozzles 516 fall through the formed liquid nitrogen mist 532 and come into direct contact with one or more liquid nitrogen microdroplets 534. This contact freezes the product beads 524 by utilizing the heat of vaporization of the liquid nitrogen to cool the warmer product beads 524. The product beads 524 fall downward a sufficient distance through the mist 532, wherein the sub-cooled cryogenic mist 532 has a sufficient density of liquid nitrogen microdroplets 534 to ensure sufficient contact between the product beads 524 and the liquid nitrogen microdroplets 534 to freeze each of the falling product beads 524.

The liquid nitrogen that contacts the product beads 524 is vaporized and the resulting liquid nitrogen gas is vented out of the chamber 510 through a venting port located at a top portion of the freezing tower according to this specific embodiment. Liquid nitrogen that is not vaporized also falls downwardly onto a liquid nitrogen separator device, while the frozen product beads 524 are caught by a product separation screen, the latter being disposed at a lower portion of the freezing chamber 510.

As in the prior embodiment, the size and velocity of the liquid nitrogen microdroplets 534 are configured such that neither the structure of the product beads 524 nor their vertically falling trajectory are not significantly and adversely affected, thus insuring that product bead integrity is maintained. That is, the product beads 524 are not split, broken or otherwise damaged due to contact by the much smaller liquid nitrogen microdroplets 534. The optimal ratio of product bead diameter to liquid nitrogen microdroplet diameter is at least 6:1 in this embodiment, but literally any ratio of 2:1 or greater will provide the needed integrity.

In an embodiment, the first cooling nozzle 526 may be a hydraulic spray nozzle suitable of atomizing liquid nitrogen. For example, the first cooling nozzle 526 may be capable of generating liquid nitrogen microdroplets 534 having a diameter of approximately 10 to 100 microns as compared to a product bead diameter of about 600 microns. The first cooling nozzle 526 may be, for example, of the type sold by Spraying Systems, Inc. of Glendale Heights, IL and designated as Fine Spray Nozzle, ¼ inch M Series or an equivalent nozzle may be used.

The first cooling nozzle 526 may be located in any section or region of the freezing tower 502 and is oriented in any direction suitable for generating a relatively dense field of liquid nitrogen microdroplets 534 in the freezing chamber 510. This positioning may include positioning at least one cooling nozzle such that the liquid nitrogen microdroplets 534 are sprayed upwardly, downwardly, or directed in or out from at least one horizontally positioned nozzle. Alternatively, a plurality of nozzles may be used that are positioned along a periphery of the sidewall of the freezing tower 502 and oriented either horizontally or sloped downwardly into the freezing chamber 510. By way of example, FIG. 7 depicts an embodiment that includes the first cooling nozzle 526 and a second cooling nozzle 538 in which both nozzles 526, 538 are configured to spray liquid nitrogen microdroplets 534 in a vertical direction. The second cooling nozzle 538 may be supplied by an associated cooling fluid source via an associated cooling fluid conduit. Alternatively, the first and second cooling nozzles 526, 538 may be supplied via a common cooling fluid source. The first cooling nozzle 526 is positioned to spray liquid nitrogen microdroplets 534 in a first vertical direction 540 (for example, downward) into the freezing chamber 510 and the second cooling nozzle 538 is positioned to spray liquid nitrogen microdroplets 534 in a second vertical direction 542 into the chamber 510 opposite to that of the first vertical direction 540 (i.e., upward) to form the sub-cooled cryogenic mist 532.

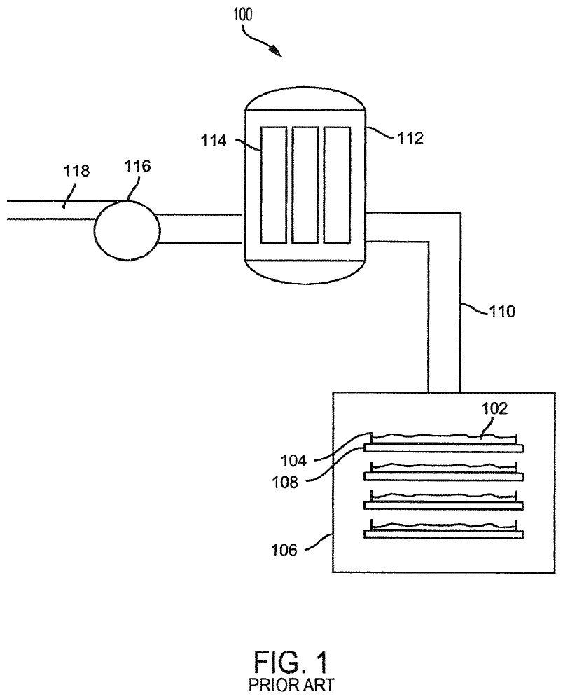

In accordance with one or more embodiments of the invention, a cooling fluid (LN2) separator device or arrangement in the freezing chamber 510 enables separation of the liquid nitrogen that was not vaporized from the product beads 524. The following is an exemplary arrangement for separating liquid nitrogen from the product beads 524. It will be understood that other methods, devices or arrangements may be used to separate liquid nitrogen from the product beads. The bottom wall 508 of the freeze tower 502 is inclined in a first inclination direction 544. The product separation screen 546 is located above the bottom wall 508 and is inclined in a second inclination direction 548, which is opposite to that of the first inclination direction 544. The product separation screen 546 receives both the frozen product beads 524 and the liquid nitrogen that was not vaporized by contact with the product beads 524. The product separation screen 546 is sized with an appropriate mesh that separates the frozen product beads 524 from the smaller liquid nitrogen microdroplets 534. The product separation screen 546 catches the frozen product beads 524, which then move under the force of gravity through a product removal outlet 550. The frozen product beads 524 are then received by a freeze drying chamber, such as previously described freeze drying chamber 110 of the freeze drying system 100 shown in FIG. 1, to undergo freeze drying to form freeze-dried product. Alternatively, the frozen product beads 524 can be collected in an insulated container (not shown) to be placed in a separate freeze dryer (not shown).

Liquid nitrogen that was not vaporized flows through the product separation screen 546 onto the inclined bottom wall 508. In an embodiment, the liquid nitrogen then flows by gravity through a liquid nitrogen outlet 552, thereby removing the liquid nitrogen from the bottom of the freeze tower 502. In another embodiment, a heating element 554 is attached beneath the bottom wall 508. The heating element serves to heat the bottom wall 508 and thus the liquid nitrogen in order to vaporize the liquid nitrogen collected at the bottom wall 508 into liquid nitrogen gas. The gas is then vented out of the chamber 510 via the venting port 536.

Due to the spraying of liquid nitrogen in the chamber when forming the mist 532 of liquid nitrogen microdroplets 534, a cold environment is formed within the chamber 510. In accordance with an aspect of the invention, an insulation jacket 558 is located in the cavity 505 to provide insulation for maintaining the cold environment. This jacketing 558 serves to maximize the duration of the liquid nitrogen microdroplets 534 as a liquid before evaporation occurs due to heat leakage in the freeze tower 502. In another embodiment, a vacuum is formed in the cavity 505 between the inner and outer sidewalls 506, 508 to provide vacuum insulation in order to further maintain the cold environment.

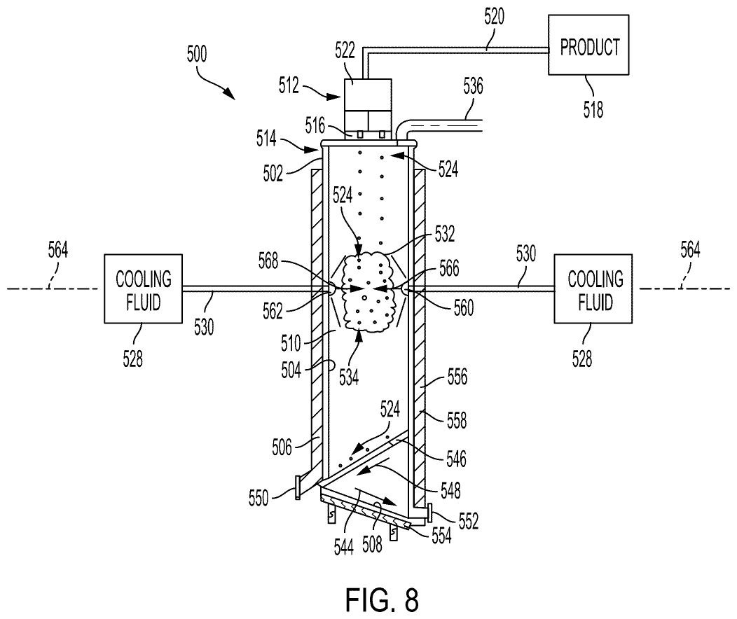

FIG. 8 depicts another alternative embodiment for the positioning of the cooling nozzles. Similar parts are labeled with the same reference numerals for the sake of clarity. In this embodiment, third and fourth cooling nozzles 560, 562 are aligned with one another and are configured and arranged to spray liquid nitrogen into the chamber 510 in a substantially horizontal direction. In this embodiment, the third cooling nozzle 560 is positioned to spray liquid nitrogen microdroplets 534 in a first horizontal direction 566 into the chamber 510 (for example, towards the fourth cooling nozzle 562) and the fourth cooling nozzle 562 is positioned to spray liquid nitrogen microdroplets 534 in a second horizontal direction 568 into the chamber 510 opposite the first direction 566 (i.e., toward the third cooling nozzle 560) to form the mist 532. Alternatively, the third and fourth cooling nozzles 560, 562 may be offset relative to one another to form a staggered or offset arrangement in which the third cooling nozzle 560, for example, is positioned above a horizontal axis 564 and the fourth cooling nozzle 562 is positioned below the horizontal axis 564. Furthermore, at least one additional cooling nozzle that sprays liquid nitrogen microdroplets 534 in a horizontal direction may be added.

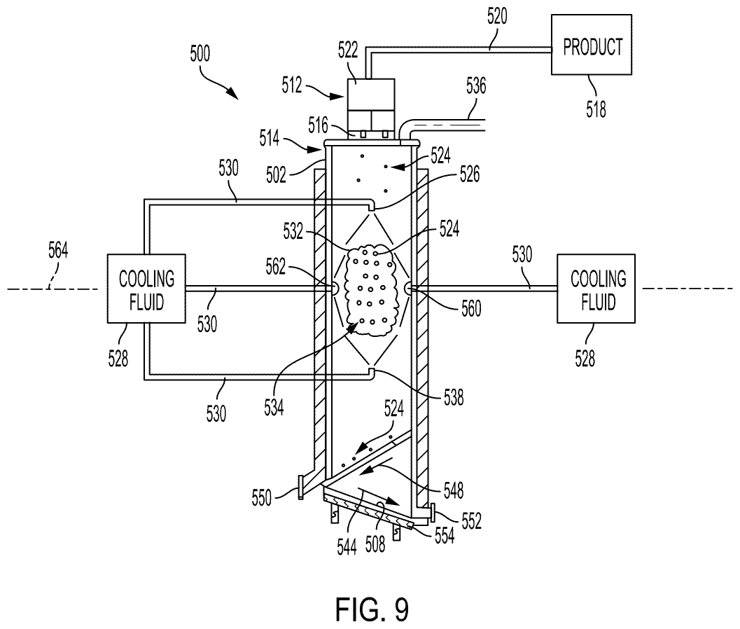

FIG. 9 depicts a further embodiment for positioning the cooling nozzles in which liquid nitrogen microdroplets 534 are sprayed by the cooling nozzles in both the horizontal and vertical directions. Again, similar parts are labeled with the same reference numerals throughout this discussion. In this specific embodiment, the first and second cooling nozzles 526, 538 are configured to spray liquid nitrogen microdroplets 534 in the first and second vertical directions 540, 542, respectively, and the third and fourth cooling nozzles 560, 562 are configured to spray liquid nitrogen microdroplets 534 in the first and second horizontal directions 566, 568 to form the mist 532. The positioning, arrangement and number of coolant nozzles may be suitably varied in order to optimize the formation of the mist 532 or the location of the mist 532 within the chamber 510 of the freeze tower 502. For example, each of the coolant nozzles may be independently movable horizontally or vertically relative to the chamber in order to optimize the formation of the mist 532 within the chamber 510. Furthermore, a spray angle of any or all of the herein described cooling nozzles may be independently adjustable.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

To the extent that the claims recite the phrase “at least one of” in reference to a plurality of elements, this is intended to mean at least one or more of the listed elements, and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed. Unless specified or limited otherwise, the terms “connected”, “supported” and “coupled” and variations thereof are used broadly and encompass direct and indirect mountings, connections, supports, and couplings. Furthermore, the terms “connected” and “coupled” are not necessarily restricted to physical or mechanical couplings or connections.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

### Parts List for FIGS. 1-9

100 freeze drying system
102 frozen product
104 trays, plurality
106 freeze drying chamber
108 freeze dryer shelves
110 passageway
112 condensing chamber
114 condensing coils or other surfaces
116 vacuum pump
118 high pressure outlet
200 direct contact spray freezing system
204 freezing tower
208 cavity or chamber
212 inner circumferential sidewall, freezing tower
216 outer circumferential sidewall, freezing tower
220 upper portion, freezing tower
224 lower portion, freezing tower
228 inwardly tapering bottom wall
234 product opening or port
240 product delivery subsystem
244 product reservoir or source
248 passageways or conduits
250 chiller
252 valves
254 passageway or fluid conduit
256 passageway or fluid conduit
262 source of sterile gas
264 passageway or fluid conduit
266 filter
268 valve
280 coolant fluid delivery subsystem
284 coolant nozzle
288 passageway or conduit
289 passageway or conduit
292 coolant fluid source
294 valve
296 gas source
298 filter
300 passageway or conduit
302 valve
304 heat exchanger
308 passageway or conduit
312 vent
320 vibratory droplet generator
324 droplet nozzle(s)
328 vibratory drive motor
329 extension or connecting rod
330 nozzle disc
334 flexible diaphragm
336 sterile space
340 additional coolant nozzle
344 valve
346 preconditioning spray of coolant fluid
348 process vent
350 droplets, liquid
354 sub-cooled cryogenic mist
356 valve
390 controller
400 process
402 step
404 step
408 step
412 step
416 step
420 step
424 step
428 step
432 step
436 step
500 direct contact spray freezing system
502 freeze vessel or tower
504 inner circumferential sidewall
505 cavity
506 outer circumferential sidewall
508 bottom wall
510 freeze chamber
512 vibratory prilling head
514 top portion
516 at least one product nozzle
518 product source
520 passageway or conduit
522 vibratory unit
524 product droplets or beads
526 cooling nozzle (first)
528 cooling fluid source
530 cooling fluid conduit
532 sub-cooled cryogenic mist
534 cooling fluid microdroplets or microparticles
536 venting port
538 second cooling nozzle
540 first vertical direction
542 second vertical direction
544 first inclination direction
546 product separation screen
548 second inclination direction
550 product removal outlet
552 cooling fluid outlet
554 heating element
558 insulation jacket
560 third cooling nozzle
562 fourth cooling nozzle
564 horizontal axis
566 first horizontal direction
568 second horizontal direction

This Detailed Description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. As noted, it will be understood that other suitable variations and modifications will be readily apparent and understood by those of sufficient skill in the field reading the preceding detailed description and as will further be understood from the following appended claims.

1. A direct contact spray freezing system comprising:
a freezing tower having an interior chamber;
at least one means for delivering bulk product in the form of liquid droplets to the interior chamber of the freezing tower; and
at least one means for delivering a coolant fluid capable of contacting and directly freezing the liquid droplets within the interior chamber of the freezing tower, wherein the liquid droplets are transformed into frozen particles collected at a lowermost portion of the freezing tower and wherein the coolant fluid is delivered in the form of a sub-cooled cryogenic mist made up of coolant fluid microparticles, and in which each of the coolant fluid microparticles are substantially smaller than the liquid droplets delivered to the interior chamber.

2. The direct contact spray freezing system according to claim 1, wherein the coolant fluid and the liquid droplets are each delivered to an upper portion of the freezing tower.

3. The direct contact spray freezing system according to claim 1, wherein the means for delivering the coolant fluid includes means for sterilizing the coolant fluid prior to delivery.

4. The direct contact spray freezing system according to claim 1, wherein the means for delivering the bulk product to the freezing tower includes a droplet generator having one or more vibratory nozzles configured to produce liquid droplets that vertically fall from the one or more vibratory nozzles under the force of gravity.

5. The direct contact spray freezing system according to claim 4, wherein the coolant fluid microparticles have an average size that is small enough not to substantially disturb the structural integrity and vertically falling trajectory of the liquid droplets of the bulk product when in direct contact therewith.

6. The direct contact spray freezing system according to claim 5, wherein a ratio of the average size of the liquid droplets to that of the average size of the coolant fluid microparticles is at least 2:1.

7. The direct contact spray freezing system according to claim 5, wherein the average size of each liquid droplet is about 600 microns and the average size of each coolant fluid microparticle is about 100 microns.

8. The direct contact spray freezing system according to claim 1, wherein the means for delivering the bulk product in the form of liquid droplets further comprises a liquid reservoir and one or more hollow tubular members disposed between the liquid reservoir and the one or more vibratory nozzles, and in which the tubular members are configured for single product or single use.

9. (canceled)

10. The direct contact spray freezing system according to claim 1, wherein the means for delivering the bulk product further comprises means for initially cooling the bulk product to a predetermined temperature prior to delivering the bulk product as liquid droplets to the interior chamber of the freezing tower.

11. The direct contact spray freezing system according to claim 1, wherein the means for delivering the coolant fluid comprises one or more coolant nozzles configured to create the sub-cooled cryogenic mist of coolant fluid microparticles.

12. (canceled)

13. (canceled)

14. The direct contact spray freezing system according to claim 1, wherein the interior chamber of the freezing tower is maintained at ambient pressure.

15. A process for freezing liquid material within a direct contact spray freezing system, the process comprising:
delivering bulk product material in the form of liquid droplets that are released into an interior chamber of a freezing tower; and
providing a coolant fluid in the form of a sub-cooled cryogenic mist through which the liquid droplets vertically pass through the interior of the freezing tower for directly freezing the liquid droplets into frozen particles;
wherein the sub-cooled cryogenic mist comprises a plurality of coolant fluid microparticles configured to directly contact the vertically falling liquid droplets in which the coolant fluid particles are substantially smaller in size such that the structural integrity and trajectory of each vertically passing liquid droplet is not significantly affected.

16. The process according to claim 15, in which the average size of the liquid droplets delivered into the interior of the freezing tower is at least 2 times larger than the average size of the coolant fluid microparticles of the sub-cooled cryogenic mist.

17. The process according to claim 15, in which the liquid droplets are released from one or more vibratory nozzles at a frequency that permits each liquid droplet to be released under the force of gravity.

18. The process according to claim 15, further comprising filtering excess coolant fluid away from the frozen particles collected at a bottom portion of the freezing tower.

19. The process according to claim 15, wherein the freezing tower is maintained at ambient pressure during the freezing process.

20. The process according to claim 15, wherein the bulk product is maintained at a constant pressure prior to delivery of the liquid to the interior of the freezing tower.

21. The process according to claim 15, further comprising initially cooling the bulk product to a predetermined temperature prior to delivering the liquid droplets into the interior chamber of the freezing tower.

22. The process according to claim 15, further comprising conditioning the interior chamber of the freezing tower to a predetermined temperature prior to delivery of the liquid droplets.

23. The process according to claim 22, wherein the conditioning the interior chamber of the freezing tower further comprises monitoring an exhaust temperature of the freezing tower and comparing the exhaust temperature to a predetermined threshold temperature, wherein delivery of the liquid droplets commences only when the exhaust temperature has been cooled to the predetermined threshold temperature or cooler.

24. The process according to claim 23, wherein the conditioning further comprises opening one or more additional coolant nozzles when the monitored exhaust temperature has not reached the predetermined threshold temperature and isolating and closing the one or more additional coolant nozzles when the predetermined threshold has been reached.

25. (canceled)

26. (canceled)

27. (canceled)

28. (canceled)
